(19) United States
(12) Patent Application Publication
(10) Pub. No.: US 2010/0092774 A1
(43) Pub. Date: Apr. 15, 2010

(54) PRESSURE SENSITIVE ADHESIVE FOR PAPER LABELS

(75) Inventors: Petra Schoecker, Buerstadt (DE); Karl-Heinz Schumacher, Neustadt (DE); Heiko Diehl, Fussgoenheim (DE); Udo Spuhler, Neustadt (DE); Erich Ettel, Worms (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/522,384

(22) PCT Filed: Jan. 14, 2008
(86) PCT No.: PCT/EP08/50339

§ 371 Date: Jul. 8, 2009

(30) Foreign Application Priority Data
Jan. 15, 2007 (EP) 07100550.8

(51) Int. Cl. C09J 133/10; B32B 5/00

(52) U.S. Cl. 428/355 EN; 524/558

(57) ABSTRACT

Paper labels coated with a pressure sensitive adhesive (PSA), wherein
the PSA comprises no vinyl acetate in free or copolymerized form and
comprises as binder an emulsion polymer synthesized from
a) 70% to 95% by weight of a C6 to C10 alkyl (meth)acrylate
b) 1% to 20% by weight of methyl methacrylate
c) 0.5% to 10% by weight of a vinylaromatic monomer
d) 0.5% to 10% by weight of a hydroxyalkyl (meth)acrylate
e) 0.5% to 5% by weight of a monomer having at least one acid or acid anhydride group
f) 0% to 10% by weight of tert-butyl (meth)acrylate and
g) 0% to 20% by weight of further monomers, the further monomers comprising not more than 3% by weight of methyl acrylate.

The invention relates to paper labels coated with a pressure sensitive adhesive (PSA), where
the PSA comprises no vinyl acetate in free or copolymerized form and
comprises as binder an emulsion polymer synthesized from
a) 70% to 95% by weight of a C6 to C10 alkyl (meth)acrylate
b) 1% to 20% by weight of methyl methacrylate
c) 0.5% to 10% by weight of a vinylaromatic monomer
d) 0.5% to 10% by weight of a hydroxyalkyl (meth)acrylate
e) 0.5% to 5% by weight of a monomer having at least one acid or acid anhydride group
f) 0% to 10% by weight of tert-butyl (meth)acrylate and
g) 0% to 20% by weight of further monomers, the further monomers comprising not more than 3% by weight of methyl acrylate.

Labels are self-adhesive articles coated with pressure sensitive adhesive (PSA). The labels are intended to adhere pretty well to any of a very wide variety of substrates. The substrates may be, for example, packaging or containers made of different materials. In the packaging segment in particular the substrates in question—packaged foods, say—are often subjected to storage at a reduced temperature for some duration. Intensely odored PSAs are out of the question for such uses. In the case of labels with paper backing material, particular requirements are imposed as a result of the porosity and associated permeability. As compared with film backing materials, the odor released by volatile ingredients is especially perceptible.

Suitable PSAs require not only effective adhesion but also sufficient internal strength within the adhesive layer (cohesion) even at low temperatures. The two properties are generally divergent—that is, an improvement in one property is accompanied by a deterioration in the other.

EP-A 625 557 discloses PSAs which as well as vinylaromatics, hydroxyalkyl acrylates, and methyl methacrylate necessarily comprise at least 5% by weight of methyl acrylate.

EP-A-1342762 describes PSAs which necessarily comprise hydroxyalkyl acrylates, vinylaromatics, and, if appropriate, vinyl acetate.

Subject matter of WO 00/68335 are pressure sensitive adhesives which are prepared with an aromatic emulsifier; the PSAs comprise various alkyl (meth)acrylates, including for example ethylhexyl acrylate and methyl methacrylate, alongside vinylaromatics, hydroxy compounds, and ethylenically unsaturated acids.

The patent application PF 58054, unpublished at the priority date of the present specification, describes PSAs which comprise hydroxy monomers and tert-butyl (meth)acrylate.

It was an object of the present invention to provide paper labels which have good performance properties, including in particular effective adhesion properties even at low temperatures; nevertheless, the cohesion ought to be sufficient, and in particular it ought to be possible to process the coated backings by slitting or diecutting paper labels.

Accordingly the paper labels defined at the outset were found.

The paper labels are coated with a pressure sensitive adhesive. The pressure sensitive adhesive comprises no vinyl acetate, either in free form or in copolymerized form.

The pressure sensitive adhesive comprises as its binder an emulsion polymer. The emulsion polymer is synthesized from:
a) 70% to 95% by weight of a C6 to C10 alkyl (meth)acrylate
b) 1% to 20% by weight of methyl methacrylate
c) 0.5% to 10% by weight of a vinylaromatic monomer
d) 0.5% to 10% by weight of a hydroxyalkyl (meth)acrylate
e) 0.5% to 5% by weight of a monomer having at least one acid or acid anhydride group
f) 0% to 10% by weight of tert-butyl (meth)acrylate and
g) 0% to 20% by weight of further monomers, the further monomers comprising not more than 3% by weight of methyl acrylate.

Preferred C6-C10 alkyl (meth)acrylates are n-butyl acrylate and 2-ethylhexyl acrylate or mixtures thereof. 2-Ethylhexyl acrylate is particularly preferred.

The amount of the C6-C10 alkyl (meth)acrylates in the emulsion polymer is preferably 75% to 95%, more preferably 78% to 90%, and very preferably 80% to 90% by weight.

The amount of the methyl methacrylate (MMA) in the emulsion polymer is preferably 3% to 15%, more preferably 4% to 12%, and very preferably 4% to 8% by weight.

A preferred vinylaromatic monomer c) is styrene.

The amount of the vinylaromatic monomer in the emulsion polymer is preferably 1% to 8%, more preferably 1% to 5%, and very preferably 2% to 5% by weight.

Preferred hydroxyalkyl (meth)acrylates are the C2 to C12 hydroxyalkyl (meth)acrylates and in particular the C2 to C6 hydroxyalkyl (meth)acrylates. Very particular preference is given to hydroxyethyl acrylate, hydroxyethyl methacrylate, hydroxypropyl acrylate, hydroxypropyl methacrylate, hydroxybutyl acrylate or hydroxybutyl methacrylate. The amount of the hydroxyalkyl (meth)acrylates in the emulsion polymer is preferably 0.5% to 8%, more preferably 1% to 5%, and very preferably 1.5% to 4% by weight.

Preferred monomers having at least one acid or acid anhydride group (e) are for example monomers having at least one, preferably one or two, carboxylic acid, sulfonic acid or phosphonic acid groups. Preference is given to carboxylic acid groups. Mention may be made, by way of example, of acrylic acid, methacrylic acid, itaconic acid, maleic acid or fumaric acid. Acrylic acid or methacrylic acid is particularly preferred. The amount of these monomers in the emulsion polymer is preferably 0.5% to 4%, more preferably 0.6% to 3.5%, and very preferably 0.8% to 3% by weight.

The emulsion polymer comprises if appropriate tert-butyl acrylate or tert-butyl (meth)acrylate (tert-butyl (meth)acrylate) for short). In one particular embodiment the emulsion polymer necessarily comprises tert-butyl (meth)acrylate. The amount of the tert-butyl (meth)acrylate in the emulsion polymer is preferably 0.2% to 10%, more preferably 0.5% to 5%, and very preferably 0.8% to 5% by weight.

If appropriate the emulsion polymer may also comprise further monomers (g). However, the emulsion polymer necessarily comprises not more than 3% by weight, preferably not more than 2% by weight, of methyl acrylate. In one particular embodiment the emulsion polymer comprises less than 0.5% by weight of methyl acrylate and in particular less than 0.1% by weight of methyl acrylate. With very particular preference the emulsion polymer comprises no methyl acrylate.

In addition there may be further monomers used, examples being other C1 to C20 alkyl (meth)acrylates (not corresponding to monomers a) to f)), ethylenically unsaturated nitriles, and ethylenically unsaturated amides.

The amount of the further monomers in the emulsion polymer may be preferably 0% to 10%, more preferably 0% to 8%, and very preferably 0% to 5% by weight. In one particular embodiment no further monomers are used.

The emulsion polymer is synthesized in total preferably from
a) 70% to 95% by weight of a C6 to C10 alkyl (meth)acrylate
b) 1% to 20% by weight of methyl methacrylate
c) 0.5% to 10% by weight of a vinylaromatic monomer
d) 0.5% to 10% by weight of a hydroxyalkyl (meth)acrylate
e) 0.5% to 5% by weight of a monomer having at least one acid or acid anhydride group
f) 0% to 10% by weight of tert-butyl (meth)acrylate
g) 0% to 20% by weight of further monomers, to the exclusion of methyl acrylate.

With particular preference it is synthesized from
a) 70% to 95% by weight of a C6 to C10 alkyl (meth)acrylate
b) 1% to 20% by weight of methyl methacrylate
c) 0.5% to 10% by weight of a vinylaromatic monomer
d) 0.5% to 10% by weight of a hydroxyalkyl (meth)acrylate
e) 0.5% to 5% by weight of a monomer having at least one acid or acid anhydride group
f) 0.2% to 10% by weight of tert-butyl (meth)acrylate
g) 0% to 20% by weight of further monomers, to the exclusion of methyl acrylate.

With very particular preference it is synthesized from
a) 75% to 95% by weight of a C6 to C10 alkyl (meth)acrylate
b) 3% to 15% by weight of methyl methacrylate
c) 1% to 8% by weight of a vinylaromatic monomer
d) 0.5% to 8% by weight of a hydroxyalkyl (meth)acrylate
e) 0.5% to 5% by weight of a monomer having at least one acid or acid anhydride group
f) 0.5% to 5% by weight of tert-butyl (meth)acrylate
g) 0% to 10% by weight of further monomers, to the exclusion of methyl acrylate.

In a special embodiment the emulsion polymer is synthesized from:
a) 78% to 90% by weight of a C6 to C10 alkyl (meth)acrylate
b) 4% to 12% by weight of methyl methacrylate
c) 1% to 5% by weight of a vinylaromatic monomer
d) 1% to 5% by weight of a hydroxyalkyl (meth)acrylate
e) 0.5% to 4% by weight of a monomer having at least one acid or acid anhydride group
f) 0.8% to 5% by weight of tert-butyl (meth)acrylate
g) 0% to 10% by weight of further monomers, to the exclusion of methyl acrylate.

In a further special embodiment the emulsion polymer is synthesized from:
a) 80% to 90% by weight of a C6 to C10 alkyl (meth)acrylate
b) 4% to 8% by weight of methyl methacrylate
c) 2% to 5% by weight of a vinylaromatic monomer
d) 1.5% to 4% by weight of a hydroxyalkyl (meth)acrylate
e) 0.6% to 3.5%, in particular 0.8% to 3% by weight of a monomer having at least one acid or acid anhydride group
f) 0.8% to 5% by weight of tert-butyl (meth)acrylate
g) 0% to 5% by weight of further monomers, to the exclusion of methyl acrylate.

The glass transition temperature of the emulsion polymer is preferably −70 to 0° C., more preferably −70 to −10° C., and very preferably −60 to −30° C.

The glass transition temperature can be determined by typical methods such as differential thermoanalysis or differential scanning calorimetry (see, e.g., ASTM 3418/82, midpoint temperature).

The preparation of the polymers takes place by emulsion polymerization; the polymer is therefore an emulsion polymer.

Emulsion polymerization involves polymerizing ethylenically unsaturated compounds (monomers) in water using ionic and/or nonionic emulsifiers and/or protective colloids or stabilizers as surface-active compounds to stabilize the monomer droplets and the polymer particles formed subsequently from the monomers.

A detailed description of suitable protective colloids is found in Houben-Weyl, Methoden der organischen Chemie, Volume XIV/1, Makromolekulare Stoffe [Macromolecular compounds], Georg-Thieme-Verlag, Stuttgart, 1961, pp. 411 to 420. Suitable emulsifiers include anionic, cationic, and nonionic emulsifiers. As surface-active substances it is preferred to use emulsifiers, whose molecular weights, unlike those of the protective colloids, are typically below 2000 g/mol. Where mixtures of surface-active substances are used the individual components must, as will be appreciated, be compatible with one another, something which in case of doubt can be checked by means of a few preliminary tests. It is preferred to use anionic and nonionic emulsifiers as surface-active substances. Common accompanying emulsifiers are, for example, ethoxylated fatty alcohols (EO degree: 3 to 50, alkyl radical: C₈ to C₃₆), ethoxylated mono-, di-, and trialkylphenols (EO) degree: 3 to 50, alkyl radical: C₄ to C₉), alkali metal salts of dialkyl esters of sulfosuccinic acid and also alkali metal salts and ammonium salts of alkyl sulfates (alkyl radical: C₈ to C₁₂), of ethoxylated alkanols (EO degree: 4 to 30, alkyl radical: C₁₂ to C₁₈), of ethoxylated alkylphenols (EO degree: 3 to 50, alkyl radical: C₄ to C₉), of alkylsulfonic acids (alkyl radical: C₁₂ to C₁₈), and of alkylarylsulfonic acids (alkyl radical: C₉ to C₁₈).

Further suitable emulsifiers are compounds of the general formula I

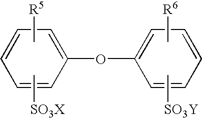

in which R⁵ and R⁶ are hydrogen or C₄ to C₁₄ alkyl and are not simultaneously hydrogen, and X and Y can be alkali metal ions and/or ammonium ions. Preferably R⁵, R⁶ are linear or branched alkyl radicals having 6 to 18 C atoms or hydrogen, and in particular having 6, 12 and 16 C atoms, R⁵ and R⁶ not both simultaneously being hydrogen. X and Y are preferably sodium, potassium or ammonium ions, with sodium being particularly preferred. Particularly advantageous compounds II are those in which X and Y are sodium, R⁵ is a branched alkyl radical having 12 C atoms, and R⁶ is hydrogen or R⁵. It is common to use technical mixtures having a fraction of 50% to 90% by weight of the monoalkylated product, an example being Dowfax® 2A1 (trademark of the Dow Chemical Company).

Suitable emulsifiers are also found in Houben-Weyl, Methoden der organischen Chemie, Volume 14/1, Makromolekulare Stoffe, Georg Thieme Verlag, Stuttgart, 1961, pages 192 to 208.

Emulsifier tradenames are, for example, Dowfax®2 A1, Emulan® NP 50, Dextrol® OC 50, Emulgator 825, Emulgator 825 S, Emulan® OG, Texapon® NSO, Nekanil® 904 S, Lumiten® I-RA, Lumiten E 3065, Disponil FES 77, Lutensol AT 18, Steinapol VSL, Emulphor NPS 25.

With particular preference the emulsion polymer is prepared using emulsifiers as described in WO 00/68335.

Particularly preferred emulsifiers are those of the above formula I, very particular preference being given to mixtures of emulsifiers of the formula I with alkoxylated fatty acid sulfates of the formula (II)

R⁸—O—(Z—O)n-SO₃₋K+

in which the variables have the following definitions:
R⁸: is C1-C18 alkyl, preferably C6 to C16 alkyl
Z: is CH2-CH2 or CH(CH3)-CH2, preferably CH2-CH2
n: is an integer from 1 to 40, preferably 2 to 30
K: is a cation, preferably an alkali metal cation or ammonium ion

The surface-active substance is used typically in amounts of 0.1% to 10% by weight, based on the monomers to be polymerized.

In the emulsion polymerization use is made typically of water-soluble initiators for the free-radical polymerization of the monomers.

Water-soluble initiators for emulsion polymerization are, for example, ammonium salts and alkali metal salts of peroxydisulfuric acid, e.g., sodium peroxodisulfate, hydrogen peroxide or organic peroxides, e.g., tert-butyl hydroperoxide.

Also suitable are what are known as reduction-oxidation (redox) initiator systems.

The redox initiator systems are composed of at least one, usually inorganic reducing agent and one organic or inorganic oxidizing agent.

The oxidizing component comprises, for example, the emulsion polymerization initiators already mentioned above.

The reducing components comprise, for example, alkali metal salts of sulfurous acid, such as sodium sulfite, sodium hydrogen sulfite, alkali metal salts of disulfurous acid such as sodium disulfite, bisulfite addition compounds of aliphatic aldehydes and ketones, such as acetone bisulfite, or reducing agents such as hydroxymethanesulfinic acid and its salts, or ascorbic acid. The redox initiator systems may be used together with soluble metal compounds whose metallic component is able to exist in a plurality of valence states.

Examples of typical redox initiator systems include ascorbic acid/iron(II) sulfate/sodium peroxydisulfate, tert-butyl hydroperoxide/sodium disulfite, tert-butyl hydroperoxide/Na-hydroxymethanesulfinic acid. The individual components, the reducing component for example, may also be mixtures: for example, a mixture of the sodium salt of hydroxymethanesulfinic acid and sodium disulfite.

The stated compounds are mostly used in the form of aqueous solutions, the lower concentration being determined by the amount of water that is acceptable in the dispersion and the upper concentration by the solubility of the respective compound in water. In general the concentration is 0.1% to 30% by weight, preferably 0.5% to 20% by weight, more preferably 1.0% to 10% by weight, based on the solution.

The amount of the initiators is generally 0.1% to 10% by weight, preferably 0.5% to 5% by weight, based on the monomers to be polymerized. It is also possible for two or more different initiators to be used for the emulsion polymerization.

In the course of the polymerization, polymerization regulators, regulators for short, can also be used. Regulators bring about a chain termination reaction and hence reduce the molar weight of the polymer. In the course of this reaction the regulators are attached to the polymer, generally to the chain end.

The amount of regulators can be, in particular, 0.05 to 4 parts by weight, more preferably 0.05 to 0.8 part by weight, and very preferably 0.1 to 0.6 part by weight, based on 100 parts by weight of the monomers to be polymerized. Suitable regulators are, in particular, compounds having a mercapto group, such as tert-butyl mercaptan, thioglycolic acid ethylacrylic esters, mercaptoethynol, mercaptopropyltrimethoxysilane or tert-dodecyl mercaptan. The regulators are generally low molecular weight compounds having a molar weight of less than 2000, in particular less than 1000 g/mol.

The emulsion polymerization takes place in general at 30 to 130, preferably 50 to 90° C. The polymerization medium may be composed either of water alone or of mixtures of water and water-miscible liquids such as methanol. Preferably only water is used. The feed process may be conducted as a staged or gradient procedure. Preference is given to the feed process, in which a portion of the polymerization mixture is introduced as an initial charge and heated to the polymerization temperature, the polymerization of this initial charge is commenced, and then the remainder of the polymerization mixture is supplied to the polymerization zone, typically by way of two or more spatially separate feed streams, of which one or more comprise the monomers in straight or emulsified form, this addition being made continuously, in stages or under a concentration gradient, and polymerization being maintained during said addition. It is also possible, in order, for example, to set the particle size more effectively, to include a polymer seed in the initial polymerization charge.

The manner in which the initiator is added to the polymerization vessel in the course of the free-radical aqueous emulsion polymerization is known to the average skilled worker. It may either be included in its entirety in the initial charge to the polymerization vessel or else introduced, continuously or in stages, at the rate at which it is consumed in the course of the free-radical aqueous emulsion polymerization. In each specific case this will depend both on the chemical nature of the initiator system and on the polymerization temperature. It is preferred to include one portion in the initial charge and to supply the remainder to the polymerization zone at the rate at which it is consumed.

A portion of the monomers can, if desired, be included in the initial charge to the polymerization vessel at the beginning of the polymerization; the remaining monomers, or all the monomers if no monomers are included in the initial charge, are added in the feed process in the course of the polymerization.

The regulator as well can be included in part in the initial charge, or added in whole or in part during the polymerization or toward the end of the polymerization.

For a high reactor space/time yield, dispersions with as high as possible a solids content are preferred. In order to be able to achieve solids contents >60% by weight, a bimodal or polymodal particle size ought to be set, since otherwise the viscosity becomes too high and the dispersion can no longer be handled. Producing a new generation of particles can be done, for example, by adding seed (EP 81 083), by adding excess quantities of emulsifier, or by adding miniemulsions. Another advantage associated with the low viscosity at high solids content is the improved coating behavior at high solids contents. One or more new generations of particles can be produced at any point in time. This point in time depends on the particle size distribution which is targeted for a low viscosity.

The monomers are added at least partly during the polymerization, continuously. In part it is also possible for monomers to be included in the initial charge to the polymerization vessel before the polymerization is commenced.

It is preferred to include not more than 30% by weight of the total amount of the monomers in the initial charge to the polymerization vessel, more preferably not more than 20% by weight, very preferably not more than 10% by weight. The remaining monomers, i.e., preferably at least 70% by weight, more preferably at least 80% by weight, very preferably at least 90% by weight, are added continuously during the polymerization. In one particular embodiment no monomers are included in the initial charge; in other words, the entirety of the monomers is run in during the polymerization.

In the feed process the individual components can be added to the reactor from the top, in the side or from below, through the reactor floor.

For the purpose of removing the residual monomers it is also possible to add further initiator after the end of the actual emulsion polymerization, i.e., after the conversion of all the monomers and after the remaining amount of tBA has been copolymerized (chemical deodorization).

In the emulsion polymerization, aqueous polymer dispersions with solids contents of generally 15% to 75% by weight, preferably of 40% to 75% by weight are obtained.

Particular preference is given to aqueous dispersions of the emulsion polymer which have an emulsion polymer content greater than 60% by weight, based on the polymer dispersion as a whole.

The emulsion polymer thus prepared is used preferably in the form of its aqueous dispersion.

The emulsion polymer is used as or in pressure sensitive adhesives (PSAs).

The PSA comprises the emulsion polymer preferably initially in the form of the aqueous polymer dispersion as has been obtained, or is obtainable, by emulsion polymerization.

The PSA may be composed exclusively of the emulsion polymer, or of its aqueous dispersion.

Alternatively the PSA may comprise further additives.

Suitable examples include a tackifier, i.e., a tackifying resin. Tackifiers are known for example from Adhesive Age, July 1987, pages 19-23 or Polym. Mater. Sci. Eng. 61 (1989), pages 588-592.

Tackifiers are, for example, natural resins, such as rosins and their derivatives formed by disproportionation or isomerization, polymerization, dimerization and/or hydrogenation. They may be present in their salt form (with, for example, monovalent or polyvalent counterions (cations)) or, preferably, in their esterified form. Alcohols used for the esterification may be monohydric or polyhydric. Examples are methanol, ethanediol, diethylene glycol, triethylene glycol, 1,2,3-propanethiol, and pentaerythritol.

Also used are hydrocarbon resins, e.g., coumarone-indene resins, polyterpene resins, hydrocarbon resins based on unsaturated CH compounds, such as butadiene, pentene, methylbutene, isoprene, piperylene, divinylmethane, pentadiene, cyclopentene, cyclopentadiene, cyclohexadiene, styrene, a-methylstyrene, and vinyltoluene.

Other compounds increasingly being used as tackifiers include polyacrylates which have a low molar weight. These polyacrylates preferably have a weight-average molecular weight M_{w} of below 30 000. The polyacrylates with preference are composed of at least 60%, in particular at least 80% by weight of C₁-C₈ alkyl (meth)acrylates.

Preferred tackifiers are natural or chemically modified rosins. Rosins are composed predominantly of abietic acid or abietic acid derivatives.

The tackifiers can be added in a simple way to the emulsion polymers, preferably to the aqueous dispersions of the polymers. In this case the tackifiers are preferably themselves in the form of an aqueous dispersion.

PSA preferably comprises tackifier. In this case the PSA comprises preferably 50% to 95% by weight of emulsion polymer and 5% to 50% by weight of tackifying resin (tackifier), based on the solids of the PSA, i.e., excluding water.

Besides tackifiers, for example, further additives may also find use, examples being thickeners, preferably associative thickeners, defoamers, plasticizers, pigments, wetting agents or fillers, in the case of the PSA utility, and may be added to the PSA.

For improved surface wetting the PSAs may comprise, in particular, wetting assistants, examples being fatty alcohol ethoxylates, alkylphenol ethoxylates, sulfosuccinic esters, nonylphenol ethoxylates, polyoxyethylenes/-propylenes or sodium dodecylsulfonates. The amount is generally 0.05 to 5 parts by weight, in particular 0.1 to 3 parts by weight, per 100 parts by weight of emulsion polymer (solids).

The PSAs are used in accordance with the invention for producing paper labels. Paper labels are self-adhesive articles with paper as their backing material. The paper is coated on at least one side, preferably on one side, with the PSA.

For the production of the paper labels, the PSA, which is liquid by virtue of its water content, can be applied directly or indirectly (by the transfer method) to paper by means of common coating techniques. The water can be removed preferably by drying at 50 to 150° C. Before or after the application of the adhesive, the coated backings can be slit to the format required for labels. For subsequent use the PSA-coated side of the substrates can be lined with a release paper, such as with a siliconized paper, for example.

The paper labels of the invention have very good performance properties. In the production of the paper labels (slitting, diecutting) the effective cohesion means that there is no, or virtually no, emergence of the PSA at the edges. The PSA adheres well to the backing (paper), has very good adhesion to the substrates, and has a high level of cohesion (internal strength within the adhesive layer). The PSA and hence the paper labels as well are odorless.

The paper labels adhere effectively to a very wide variety of substrates, including substrates having nonpolar surfaces. The substrates may for example be packaging or containers made of different materials. In the packaging segment in particular the substrates in question, packaged foodstuffs for example, are often substrates which are subjected to low-temperature storage on a long-term basis.

The paper labels are therefore also suitable for substrates having a temperature in the range from −5 to 10° C., in particular −5 to 5° C., i.e., which are stored at these temperatures.

### EXAMPLES

In a 2-liter polymerization reactor with anchor stirrer and heating/cooling apparatus a mixture of 200 g of water and 0.75 g of ascorbic acid was heated to 90° C. under a nitrogen atmosphere. Added to this mixture at the aforementioned temperature are 23.5 g of a 7 percent strength by weight aqueous solution of sodium peroxodisulfate. After 5 minutes feed stream 1 is commenced and metered in over the course of 5 hours. Over the course of 45 minutes, feed stream 1 is increased to 4.5 times the speed. At the same time as feed stream 1, the addition is commenced of 126.5 g of a 7 percent strength by weight solution of sodium peroxodisulfate, which is metered in at a constant rate over 300 minutes.

Subsequently the batch is partly neutralized using 3 g of sodium hydroxide in 58 g of water, and, finally, 30 g of a 10% strength solution of tert-butyl peroxide in water and 36 g of an acetone bisulfite solution in water are metered in simultaneously with stirring. Lastly, at 90° C. over 15 minutes, 15 g of an aqueous solution (50% strength) of a sulfosuccinic acid dioctyl ester are added. The solids content is adjusted to 66-70%.

### Feed Stream 1:

175 g of water
46.9 g of a 32% strength aqueous solution of the sodium salt of the sulfuric monoester of dodecanol ethoxylated with 30 ethylene oxide units (Disponil FES 77)
6.7 g of a 45% strength solution of the sodium salt of the diphenyl ether derivatized with a C12-C14 alkyl radical and with two sulfonyl radicals (Dowfax 2A1)
18 g of a 25% strength aqueous solution of sodium hydroxide

| | | |
|---|---|---|
| 15 | g of acrylic acid | (1%) |
| 1320 | g of 2-ethylhexyl acrylate | (88%) |
| 30 | g of 2-hydroxypropyl acrylate | (2%) |
| 90 | g of methyl methacrylate | (6%) |
| 45 | g of styrene | (3%) |

For the other examples the procedure of E1 was repeated, with the difference that in feed stream 1 the monomer amounts indicated in the table below were used.

| | E1 | E2 | V1 | V2 | E3 | V3 | V4 |
|---|---|---|---|---|---|---|---|
| Acrylic acid | 1 | 1 | 1 | 1 | 1 | 1 | 1 |
| 2-Ethylhexyl acrylate | 88 | 87 | 82 | 77 | 87 | 80 | 75 |
| 2-Hydroxypropyl | 2 | 2 | 2 | 2 | 2 | 2 | 2 |
| acrylate | | | | | | | |
| Methyl acrylate | 0 | 2 | 7 | 12 | 0 | 7 | 12 |
| Methyl methacrylate | 6 | 5 | 5 | 5 | 5 | 5 | 5 |
| tert-Butyl acrylate | 0 | 0 | 0 | 0 | 2 | 2 | 2 |
| Styrene | 3 | 3 | 3 | 3 | 3 | 3 | 3 |

### Adhesive Values:

| | | | Quickstick | Quickstick | Peel strength |
|---|---|---|---|---|---|
| | | | FTM09 PE | FTM09 card | FTM01 card |
| | MA | t-BA | at 0° C. | at 23° C. | at 23° C. |
| | [pphm] | [pphm] | [N/25 mm] | [N/25 mm] | [N/25 mm] |
| E1 | 0 | 0 | 12 | 7 | 14 |
| E2 | 2 | 0 | 12 | 7 | 15 |
| V1 | 7 | 0 | 8 | 6 | 12 |
| V2 | 12 | 0 | 3 | 5 | 11 |
| E3 | 0 | 2 | 12.5 | 7.5 | 16 |
| V3 | 7 | 2 | 8.5 | 6.5 | 14 |
| V4 | 12 | 2 | 3.5 | 5 | 9 |

### Tests:

For the tests the dispersions were each blended with 20 parts of a tackifier dispersion based on a partially hydrogenated abietic ester. After an aging time of 24 h, the adhesives were applied in a thickness of 20 μm to a label paper (80 g/m²). To determine the peel strength in accordance with Finat Test Method 01, the coated papers were adhered to the test surface (indicated above; polyethylene or card) and after 1 minute were subjected to the peel test in a tensile machine. The Quickstick measurements were made in accordance with Finat Test Method 09, again in a tensile machine; in this test, the coated label paper is formed into a loop, the coated side is contacted with the test surface, and a measurement is made of the force (N/25 mm) required for removal.

1. A paper label coated with a pressure sensitive adhesive (PSA), wherein
the PSA comprises no vinyl acetate in free or copolymerized form and
the PSA comprises as a binder an emulsion polymer synthesized from
a) 70% to 95% by weight of a C6 to C10 alkyl (meth)acrylate
b) 1% to 20% by weight of methyl methacrylate
c) 0.5% to 10% by weight of a vinylaromatic monomer
d) 0.5% to 10% by weight of a hydroxyalkyl (meth)acrylate
e) 0.5% to 5% by weight of a monomer having at least one acid or acid anhydride group
f) 0% to 10% by weight of tert-butyl (meth)acrylate and
g) 0% to 20% by weight of further monomers, the further monomers comprising not more than 3% by weight of methyl acrylate.

2. The paper label according to claim 1, wherein the emulsion polymer is synthesized from
a) 70% to 95% by weight of a C6 to C10 alkyl (meth)acrylate
b) 1% to 20% by weight of methyl methacrylate
c) 0.5% to 10% by weight of a vinylaromatic monomer
d) 0.5% to 10% by weight of a hydroxyalkyl (meth)acrylate
e) 0.5% to 5% by weight of a monomer having at least one acid or acid anhydride group
f) 0% to 10% by weight of tert-butyl (meth)acrylate
g) 0% to 20% by weight of further monomers, to the exclusion of methyl acrylate.

3. The paper label according to claim 1, wherein the emulsion polymer is synthesized from
a) 70% to 95% by weight of a C6 to C10 alkyl (meth)acrylate
b) 1% to 20% by weight of methyl methacrylate
c) 0.5% to 10% by weight of a vinylaromatic monomer
d) 0.5% to 10% by weight of a hydroxyalkyl (meth)acrylate
e) 0.5% to 5% by weight of a monomer having at least one acid or acid anhydride group
f) 0.2% to 10% by weight of tert-butyl (meth)acrylate
g) 0% to 20% by weight of further monomers, to the exclusion of methyl acrylate.

4. The paper label according to claim 1, wherein the emulsion polymer is synthesized from
a) 75% to 95% by weight of a C6 to C10 alkyl (meth)acrylate
b) 3% to 15% by weight of methyl methacrylate
c) 1% to 8% by weight of a vinylaromatic monomer
d) 0.5% to 8% by weight of a hydroxyalkyl (meth)acrylate
e) 0.5% to 5% by weight of a monomer having at least one acid or acid anhydride group
f) 0.5% to 5% by weight of tert-butyl (meth)acrylate
g) 0% to 10% by weight of further monomers, to the exclusion of methyl acrylate.

5. The paper label according to claim 1, wherein the PSA comprises 50% to 95% by weight of emulsion polymer and 5% to 50% by weight of tackifying resin (tackifier) (based on the solids of the PSA, i.e., excluding water).

6. A substrate at a temperature in the range of −5 to 10° C. comprising the paper label according to claim 1.

7. An aqueous polymer dispersion comprising an emulsion polymer synthesized from
a) 75% to 95% by weight of a C6 to C10 alkyl (meth)acrylate
b) 3% to 15% by weight of methyl methacrylate
c) 1% to 8% by weight of a vinylaromatic monomer
d) 0.5% to 8% by weight of a hydroxyalkyl (meth)acrylate
e) 0.5% to 5% by weight of a monomer having at least one acid or acid anhydride group
f) 0.5% to 5% by weight of tert-butyl (meth)acrylate
g) 0% to 10% by weight of further monomers, to the exclusion of methyl acrylate.
